(19) United States
(12) Patent Application Publication
(10) Pub. No.: US 2017/0135140 A1
(43) Pub. Date: May 11, 2017

(54) METHOD, MOBILE TERMINAL AND NETWORK ELEMENT FOR ESTABLISHING A COMMUNICATION CONNECTION, PREFERABLY AN IP AND/OR DATA CONNECTION, BETWEEN A MOBILE TERMINAL IN A MOBILE COMMUNICATION NETWORK AND A SERVICE PROVIDER IN A DATA COMMUNICATION NETWORK

(71) Applicant: VODAFONE GMBH, Duesseldorf (DE)

(72) Inventors: Lu YANG, Duesseldorf (DE); Peter WILD, Krefeld (DE); Juergen CALDENHOVEN, Duesseldorf (DE)

(21) Appl. No.: 15/348,537

(22) Filed: Nov. 10, 2016

(30) Foreign Application Priority Data
Nov. 11, 2015 (EP) 15194023.6

(51) Int. Cl. H04W 76/02; H04W 4/02

(52) U.S. Cl. CPC H04W 76/021; H04W 4/025; H04W 84/042

(57) ABSTRACT

A method is provided for establishing a communication connection, preferably an IP and/or data connection, between a mobile terminal in a mobile communication network and a service provider in a data communication network. The method includes: sending a request for establishing the communication connection between the mobile terminal in the mobile communication network and the service provider in the data communication network originating from an application or type of application of the mobile terminal to a network element of the mobile communication network; determining the application or type of application requesting the communication connection; determining the location of the mobile terminal in the mobile communication network; identifying a gateway between the mobile communication network and the data communication network; and establishing the requested communication connection between the mobile terminal in the mobile communication network and the service provider in the data communication network via the identified gateway.

### CROSS REFERENCE TO RELATED APPLICATION

This application claims priority to European Patent Application No. 15 194 023.6 filed on Nov. 11, 2015, the disclosure of which is incorporated herein by reference.

### TECHNICAL FIELD

The invention relates to a method for establishing a communication connection, preferably an IP and/or data connection, between a mobile terminal in a mobile communication network and a service provider in a data communication network.

The invention further relates to a mobile terminal, which is adapted to perform the method steps according to the invention performed by such a mobile terminal.

The invention further relates to a network element of a mobile communication network, which is adapted to perform the method steps according to the invention performed by such a network element of a mobile communication network.

### BACKGROUND

A communication connection between a mobile terminal in a mobile communication network and a service provider in a data communication network is established via a gateway between the mobile communication network and the data communication network. The present method for establishing such a communication connection between the mobile terminal in the mobile communication network and the service provider in the data communication network according to the 3GPP standard TS 24.301 uses pre-defined access point names (APNs) to define the gateway, particularly a packet data network gateway (PGW), between the mobile communication network and the data communication network.

The APNs are pre-configured in the universal subscriber identity module (USIM) of the mobile terminal and the network element, like the home subscriber server (HSS) or the mobility management entity (MME), of the mobile communication network. The network element of the mobile communication network receives a request for establishing the communication connection between the mobile terminal in the mobile communication network and the service provider in the data communication network from the mobile terminal. This request comprises one of the APNs pre-configured in the USIM of the mobile terminal. Since the APNs are also pre-defined in the network element of the mobile communication network, the network element can define the gateway for the communication connection between the mobile terminal in the mobile communication network and the service provider in the data communication network based on the APN of the received request. The network element of the mobile communication network establishes the communication connection between the mobile terminal in the mobile communication network and the service provider in the data communication network vie the gateway defined by the APN of the received request. Thus, the gateway for the established communication connection is limited to the pre-defined APNs and static for the whole lifetime of the communication connection.

To distribute data traffic originating from different applications of the mobile terminal to different gateways the operator of the mobile communication network has to administer multiple APNs in the USIM of the mobile terminal and the network elements of the mobile communication network, so that multiple communication connections via individual gateways can be established.

### SUMMARY

It is an object of the present invention to provide a flexible method for establishing a communication connection, preferably an IP and/or data connection, between a mobile terminal in a mobile communication network and a service provider in a data communication network, particularly with respect to defining the gateway between the mobile communication network and the data communication network.

The object is achieved by a method for establishing a communication connection, preferably an IP and/or data connection, between a mobile terminal in a mobile communication network and a service provider in a data communication network, comprising the steps of:
sending a request for establishing the communication connection between the mobile terminal in the mobile communication network and the service provider in the data communication network originating from an application or type of application of the mobile terminal to a network element of the mobile communication network,
determining the application or type of application requesting the communication connection;
determining the location of the mobile terminal in the mobile communication network;
identifying a gateway between the mobile communication network and the data communication network by the network element of the mobile communication network for the requested communication connection by considering the determined application or type of application requesting the communication connection and the determined location of the mobile terminal in the mobile communication network; and
establishing the requested communication connection between the mobile terminal in the mobile communication network and the service provider in the data communication network by the network element of the mobile communication network via the identified gateway between the mobile communication network and the data communication network.

According to the invention the application or type of application requesting the communication connection between the mobile terminal in the mobile communication network and the service provider in the data communication network is determined. Further, the location of the mobile terminal in the mobile communication network is determined. Using this determined information the network element of the mobile communication network can dynamically identify a gateway to the data communication network in which the service provider is located. For example the application or type of application specifies the type of the required communication connection, e.g. voice, data, video, and so on. The location of the mobile terminal in the mobile communication network can be for example used to identify a gateway which is close to the mobile terminal.

Thus, in contrast to the currently used methods for establishing the communication connection between the mobile terminal in a mobile communication network and the service provider in the data communication network the method according to the invention does not base on pre-defined and pre-configured APNs. Instead, the present invention dynamically identifies the gateway between the mobile communication network and the data communication network for every request for establishing the communication connection between the mobile terminal in the mobile communication network and the service provider in the data communication network originating from an application or type of application of the mobile terminal.

For every request received at the network element of the mobile communication network a gateway between the mobile communication network and the data communication network is identified by the method according to the invention. Because of the different applications or types of application usually running on a mobile terminal the requested communication connections will be established via several gateways since different applications or types of applications have different requirements with respect to the requested communication connection. Thus, an automatic traffic distribution is achieved by the inventive method.

Further, there is no need to pre-define and pre-configure APNs at the mobile terminal and the network elements of the mobile communication network.

According to an embodiment of the invention the application or type of application requesting the communication connection is determined by the mobile terminal or the network element of the mobile communication network. The mobile terminal can determine the application or type of application because the application is running on the mobile terminal and thus, the mobile terminal has all relevant information of the application. The network element of the mobile communication network can determine the application or type of application by analyzing the request for establishing the communication connection between the mobile terminal in the mobile communication network and the service provider in the data communication network because this request is initiated by the application requesting the communication connection between the mobile terminal in the mobile communication network and the service provider in the data communication network.

In an advantageous embodiment of the invention the application or type of application requesting the communication connection between the mobile terminal in the mobile communication network and the service provider in the data communication network is determined by considering the communication address of the service provider, the kind of requested service, the kind of the requested communication connection and/or the name of the application requesting the communication connection. The application or kind of application can be determined by considering the communication address of the service provider if only one service is provided by the service provider under this communication address, like for example the service provider only provides a video service under the communication address. The application or kind of application can be determined by considering the kind of requested service if this kind of requested service is specific for the application or kind of application requesting the communication connection between the mobile terminal in the mobile communication network and the service provider in the data communication network. The application or kind of application can be further determined by considering the kind of the requested communication connection if this kind of requested communication connection is specific for the application or kind of application requesting the communication connection between the mobile terminal in the mobile communication network and the service provider in the data communication network, like for example a voice connection which is at least specific for a certain type of application. Further, the application or kind of application can be determined by considering the name of the application requesting the communication connection between the mobile terminal in the mobile communication network and the service provider in the data communication network. According to the invention the application or kind of application can be determined by considering any combination of the aforementioned features.

According to a further advantageous embodiment of the invention the application or type of application is assigned an identifier, wherein the identifier is at least known to the mobile terminal and the network element of the mobile communication network. Thus, only the identifier of the application or kind of application has to be transmitted between the mobile terminal and the network element of the mobile communication network.

In a preferred embodiment of the invention the identifier of the application or type of application requesting the communication connection is assigned by the mobile terminal, the network element of the mobile communication network or the application requesting the communication connection. The mobile terminal and the network element of the mobile communication network each know the identifiers which can be assigned to applications or kind of applications requesting the communication connection between the mobile terminal and the service provider in the data communication network and thus can assign the identifier to the application or type of application requesting the communication connection between the mobile terminal and the service provider in the data communication network. If the application also has knowledge of the identifier assigned to it, the application can directly include this identifier identifying the application or type of application into the request for establishing the communication connection between the mobile terminal in the mobile communication network and the service provider in the data communication network.

According to an embodiment of the invention the network element of the mobile communication network receiving the identifier of the application or type of application requesting the communication connection between the mobile terminal in the mobile communication network and the service provider in the data communication network checks the received identifier of the application or type of application requesting the communication connection. This check at the network element of the mobile communication network guarantees that neither the application nor the mobile terminal can include an identifier into the request for establishing the communication connection between the mobile terminal in the mobile communication network and the service provider in the data communication network which does not belong to the application requesting the communication connection between the mobile terminal in the mobile communication network and the service provider in the data communication network.

In a preferred embodiment of the invention the check of the received identifier of the application or type of application requesting the communication connection between the mobile terminal in the mobile communication network and the service provider in the data communication network bases on the communication address of the service provider, the kind of requested service, the kind of the requested communication connection and/or the name of the application requesting the communication connection. Based on these features the network element of the mobile communication network can easily check whether the identifier of the application or type of application included in the received request for establishing a communication connection between the mobile terminal in the mobile communication network and the service provider in the data communication network corresponds to the application requesting the communication connection between the mobile terminal in the mobile communication network and the service provider in the data communication network or not.

In an advantageous embodiment of the invention the location of the mobile terminal in the mobile communication network is determined by a cell of the mobile communication network where the mobile terminal resides, a GPS position of the mobile terminal transmitted from the mobile terminal to the network element of the mobile communication network and/or a triangulation process using transmission times of transmitted signals. The mobile communication network in which the mobile terminal is located has knowledge about the cell in which the mobile terminal is located. This information, for example the cell-ID, can be used to determine the location of mobile terminal in the mobile communication network. The location of the mobile terminal in the mobile communication network can also be determined using a Global Positioning System (GPS) module of the mobile terminal and forwarding the GPS information to the network element of the mobile communication network. Additionally or alternatively the location of the mobile terminal in the mobile communication network can be determined by a triangulation process using transmission times of transmitted signals, preferably of signals transmitted from the network element of the mobile communication network to the mobile terminal.

According to a preferred embodiment of the invention the gateway between the mobile communication network and the data communication network is identified by the network element of the mobile communication network by considering the determined application or type of application requesting the communication connection between the mobile terminal in the mobile communication network and the service provider in the data communication network and the determined location of the mobile terminal in the mobile communication network with respect to transmission times, latency, available bandwidth, network congestion, number of communication networks and/or network elements involved, quality of service, security characteristics of the communication connection, the real distance between the mobile terminal and the service provider, the capacity and/or current workload of the service provider, or any combination thereof. Depending on the requirements of the application or type of application requesting the communication connection between the mobile terminal in the mobile communication network and the service provider in the data communication network the network element can identify the best gateway considering one or more of the aforementioned characteristics. If for example a voice connection is requested, the transmission time, latency and quality of service are more important than bandwidth and security.

In a preferred embodiment of the invention the gateway between the mobile communication network and the data communication network is dynamically identified by the network element of the mobile communication network for every request for establishing a specific communication connection between the mobile terminal in the mobile communication network and a specific service provider in the data communication network originating from a specific application or type of application of the mobile terminal. Thus, every request for establishing a data connection between a mobile terminal in a mobile communication network and a service provider in a data communication network is handled separately and the most suitable gateway for each requested connection is identified. Because of the different applications or types of application usually running on a mobile terminal the requested communication connections will be established via several gateways since different applications or types of applications have different requirements with respect to the requested communication connection. Thus, an automatic traffic distribution is achieved by the inventive method.

According to an embodiment of the invention different applications with similar requirements regarding communication connections are grouped to a type of application. If applications have similar requirements regarding communication connections these applications are grouped to a type of application, which simplifies the handling at the mobile terminal and the network element of the mobile communication network because not every application has to be considered during the inventive method, it is sufficient if the applications belong to a type of application.

In a preferred embodiment of the invention the mobile communication network is designed according to a telecommunication standard like 2G, 3G, 4G, 5G, Wireless LAN or WiMAX.

In a further preferred embodiment of the invention the network element is a mobility management entity (MME) of a mobile communication network according to the 4G standard.

According to a further preferred embodiment of the invention the gateway between the mobile communication network and the data communication network is a data packet network gateway (PGW) of a mobile communication network according to the 4G standard.

### BRIEF DESCRIPTION OF THE DRAWINGS

Further details, characteristics and advantages of the invention are explained in the following in more detail based on the description of the exemplary embodiments shown in the figures of the drawings.

FIG. 1 shows schematic view of a system implementing the inventive method;

FIG. 2 shows a signal flow diagram of the inventive method; and

FIG. 3 shows a flow diagram of the inventive method.

### DETAILED DESCRIPTION

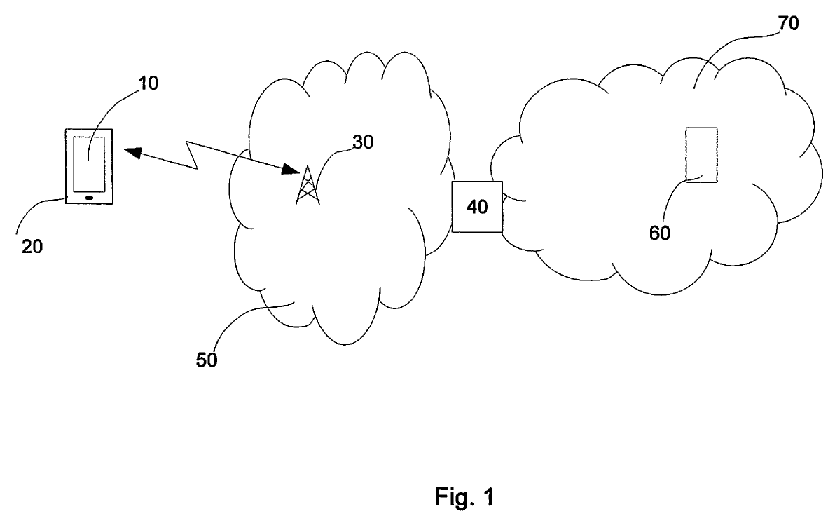

FIG. 1 shows a schematic view of a system implementing the inventive method. The system comprises a mobile communication network 50 and a data communication network 70, which are connected to each via a gateway 40. The mobile communication network comprises one or more network elements 30. Usually each network element 30 provides a so-called mobile radio cell. Mobile terminals 20 located in such a mobile radio cell of a mobile communication network 50 can connect to the network element 30 of the mobile communication network 50 via a radio link. Once connected, the mobile terminal 20 and/or an application 10 running on the mobile terminal 20 can request an establishment of a communication connection for example between the mobile terminal 20 and a service provider 60 in the data communication network 70.

The invention bases on the fact, that the mobile terminal 20 is connected or attached to the mobile communication network 50. The application 10 running on the mobile terminal 20 wants to establish a communication connection, for example an IP and/or data connection, to the service provider 60 in the data communication network 70. Therefore, the application 20 triggers the mobile terminal 20 to send a request for establishing the communication connection between the mobile terminal 20 in the mobile communication network 50 and the service provider 60 in the data communication network 70. The mobile terminal 20 sends the request originating from the application 10 of the mobile terminal 20 to the network element 30 of the mobile communication network 50.

Regarding this request it is determined which application 10 is requesting the communication connection between the mobile terminal 20 and the service provider 60. This determination can be either performed by the mobile terminal 20 or the network element 30 of the mobile communication network 50. If the mobile terminal 20 determines the application 10 requesting the communication connection between the mobile terminal 20 and the service provider 60, the mobile terminal will include the result of this determination into the request send to the network element 30 of the mobile communication network 50.

The application 10 requesting the communication connection between the mobile terminal 20 and the service provider 60 can be for example determined by considering the communication address of the service provider 60, the kind of requested service, the kind of requested communication connection and/or the of the application 10 requesting the communication connection.

According to a preferred embodiment of the invention different applications 10 with similar requirements regarding communication connections are grouped to a type of applications.

To further simplify the determination of the application 10 requesting the communication connection between the mobile terminal 20 and the service provider 60, the application 10 or type of application is assigned an identifier, wherein the identifier is at least known to the mobile terminal 20 and the network element 30 of the mobile communication network 50.

Based on the assigned identifier the application 10 or kind of application can be easily determined. For example the network element 30 of the mobile communication network 50 only has to check the identifier assigned to the application 10 or type of application.

The identifier of the application 10 or type of application requesting the communication connection between the mobile terminal 20 and the service provider 60 can be assigned by the mobile terminal 20, the network element 30 of the mobile communication network 50 or the application 10 requesting the communication connection between the mobile terminal 20 and the service provider 60.

If the network element 30 of the mobile communication network 50 receives the identifier assigned to the application 10 or type of application from the mobile terminal 20 or the application 10, the network element 30 of the mobile communication network 50 checks the received identifier of the application 10 or type of application requesting the communication connection between the mobile terminal 20 and the service provider 60. This check can for example base on the communication address of the service provider 60, the kind of requested service, the kind of requested communication connection and/or the name of the application 10 requesting the communication connection between the mobile terminal 20 and the service provider 60.

After the application 10 or tape of application has been determined, the location of the mobile terminal 20 in the mobile communication network 50 is determined. The location of the mobile terminal 20 in the mobile communication network 50 can be determined for example by identifying the cell of the mobile communication network 50 where the mobile terminal 20 resides, by a GPS position of the mobile terminal 20 transmitted from the mobile terminal 20 to the network element 30 of the mobile communication network 50 and/or by a triangulation process using transmission times of transmitted signals.

Considering the determined application 10 or type of application requesting the communication connection between the mobile terminal 20 and the service provider 60 and considering the determined location of the mobile terminal 20 in the mobile communication network 50 the gateway 40 between the mobile communication network 50 and the data communication network 70 can be identified by the network element 30 of the mobile communication network 50.

The gateway 40 between the mobile communication network 50 and the data communication network 70 is identified by the network element 30 of the mobile communication network 50 for example by considering the determined application 10 or type of application requesting the communication connection between the mobile terminal 20 and the service provider 60 and the determined location of the mobile terminal 20 in the mobile communication network 50 with respect to transmission times, latency, available bandwidth, network congestion, number of communication networks and/or network elements involved, quality of service, security characteristics of the communication connection, the real distance between the mobile terminal 20 and the service provider 60, the capacity and/or current workload of the service provider 60 or any combination thereof.

Advantageously the gateway 40 between the mobile communication network 50 and the data communication network 70 is dynamically identified by the network element 30 of the mobile communication network 50 for every request for establishing a specific communication connection between the mobile terminal 20 in the mobile communication network 50 and a specific service provider 60 in the data communication network 70 originating from a specific application 10 or type of application of the mobile terminal 20.

Finally the requested communication connection between the mobile terminal 20 in the mobile communication network 50 and the service provider 60 in the data communication network 70 is established by the network element 30 of the mobile communication network 50 via the identified gateway 40 between the mobile communication network 50 and the data communication network 70.

According to the invention the application 10 or type of application requesting the communication connection between the mobile terminal 20 in the mobile communication network 50 and the service provider 60 in the data communication network 70 is determined. Further, the location of the mobile terminal 20 in the mobile communication network 50 is determined. Using this determined information the network element 30 of the mobile communication network 50 can dynamically identify a gateway 40 to the data communication network 70 in which the service provider 60 is located. For example the application 10 or type of application specifies the type of the required communication connection, e.g. voice, data, video, and so on. The location of the mobile terminal 20 in the mobile communication network 50 can be for example used to identify a gateway 40 which is close to the mobile terminal 20.

In contrast to the currently used methods for establishing the communication connection between the mobile terminal 20 in a mobile communication network 50 and the service provider 60 in the data communication network 70 the method according to the invention does not base on pre-defined and pre-configured APNs. Instead, the present invention dynamically identifies the gateway 40 between the mobile communication network 50 and the data communication network 70 for every request for establishing the communication connection between the mobile terminal 20 in the mobile communication network 50 and the service provider 60 in the data communication network 70 originating from an application 10 or type of application of the mobile terminal 20.

According to a preferred embodiment of the invention the mobile communication network 50 is designed according to a telecommunication standard like 2G, 3G, 4G, 5G, Wireless LAN or WiMAX. If the mobile communication network 50 corresponds to the 4G standard, the network element 30 is for example a mobility management entity (MME) and the gateway 40 is a packet data network gateway (PGW).

The mobile terminal 20 and the network element 30 shown in FIG. 1 are adapted to perform the method steps according to the invention performed by such a mobile terminal 20 respectively network element 30.

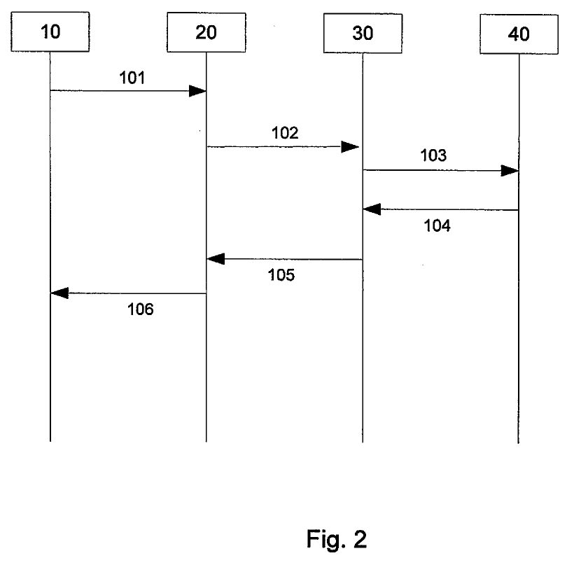

FIG. 2 shows a signal flow diagram of an embodiment of the inventive method. The invention bases on the fact, that the mobile terminal 20 is connected or attached to the mobile communication network 50. The application 10 running on the mobile terminal 20 wants to establish a communication connection, for example an IP and/or data connection, to the service provider 60 in the data communication network 70.

To establish the communication connection between the mobile terminal 20 in the mobile communication network 50 and the service provider 60 in the data communication network 70 the application 10 running on the mobile terminal 20 sends a request 101 for establishing the communication connection between the mobile terminal 20 in the mobile communication network 50 and the service provider 60 in the data communication network 70 to the mobile terminal 20. The mobile terminal 20 will send a corresponding request 102 to the network element 30 of the mobile communication network 30.

As in detail explained with respect to FIG. 1 the application 10 or type of application requesting the communication connection between the mobile terminal 20 and the service provider 60 is determined, as well as the location of the mobile terminal 20 in the mobile communication network 50.

After the network element 30 of the mobile communication network 50 has identified a gateway 40 between the mobile communication network 50 and the data communication network 70 for the requested communication connection between the mobile terminal 20 and the service provider 60 the network element 30 of the mobile communication network 50 sends a request 104 to the identified gateway 40 to establish a communication connection between the network element 30 and the gateway 40, like for example a request for establishing a bearer between the network element 30 and the gateway 40. If the mobile communication network 50 corresponds to the Long Term Evolution (LTE) standard, the network element 30 is a mobility management entity (MME) and the gateway 40 is a packet data network gateway (PGW) and between the MME and the PGW a bearer service is established for the communication connection between the mobile terminal 20 and the service provider 60.

The gateway 40 sends a response 104 to the network element 30 of the mobile communication network 50 in which the communication connection between the network element 30 and the gateway 40 is acknowledged.

Afterwards the network element 30 sends a response 105 to the mobile terminal 20 in which the request for establishing the communication connection between the mobile terminal 20 and the service provider 60 is acknowledged. This response 105 may contain information about the communication connection between the network element 30 and the gateway 40.

Finally, the mobile terminal 20 sends a response 106 to the application 10 in which the request for establishing the communication connection between the mobile terminal 20 and the service provider 60 is acknowledged.

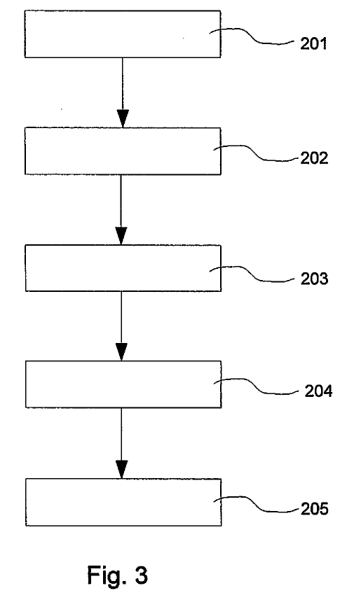

FIG. 3 shows a flow diagram of the inventive method. The invention bases on the fact, that the mobile terminal 20 is connected or attached to the mobile communication network 50. The application 10 running on the mobile terminal 20 wants to establish a communication connection, for example an IP and/or data connection, to the service provider 60 in the data communication network 70.

First, a request for establishing the communication connection between the mobile terminal 20 in the mobile communication network 50 and the service provider 60 in the data communication network 70 originating from an application 10 or type of application of the mobile terminal 20 is send 201 to the network element 30 of the mobile communication network 50.

According to the invention the application 10 or type of application requesting the communication connection between the mobile terminal 20 and the service provider 60 is determined 202.

Further, the location of the mobile terminal 20 in the mobile communication network 50 is determined 203.

Details regarding the determination 202 of the application 10 or type of application requesting the communication connection and regarding the determination 203 of the location of the mobile terminal in the mobile communication network 50 have been disclosed with respect to the embodiment of FIG. 1, which also apply to the embodiment of FIGS. 2 and 3.

By considering the determined 202 application 10 or type of application requesting the communication connection and the determined 203 location of the mobile terminal 20 in the mobile communication network 50 the network element 30 of the mobile communication network 50 identifies 204 the gateway 40 between the mobile communication network 50 and the data communication network 70 for the requested communication connection between the mobile terminal 20 and the service provider 60.

Finally, the requested communication connection between the mobile terminal 20 in the mobile communication network 50 and the service provider in the data communication network 70 is established 205 by the network element 30 of the mobile communication network 50 via the identified 204 gateway 40 between the mobile communication network 50 and the data communication network 70.

### LIST OF REFERENCE NUMERALS

10 application
20 mobile terminal
30 network element
40 gateway
50 mobile communication network
60 service provider
70 data communication network
101 request send from application to mobile terminal
102 request send from mobile terminal to network element
103 create connection request
104 create connection response
105 request response send from network element to mobile terminal
106 request response send from mobile terminal to application
201 sending request
202 determining application or type of application
203 determining location of mobile terminal
204 identifying gateway
205 establishing communication connection

What is claimed is:

1. A method for establishing a communication connection, preferably an IP and/or data connection, between a mobile terminal in a mobile communication network and a service provider in a data communication network, comprising the steps of:
sending a request for establishing the communication connection between the mobile terminal in the mobile communication network and the service provider in the data communication network originating from an application or type of application of the mobile terminal to a network element of the mobile communication network;
determining the application or type of application requesting the communication connection;
determining the location of the mobile terminal in the mobile communication network;
identifying a gateway between the mobile communication network and the data communication network by the network element of the mobile communication network for the requested communication connection by considering the determined application or type of application requesting the communication connection and the determined location of the mobile terminal in the mobile communication network; and
establishing the requested communication connection between the mobile terminal in the mobile communication network and the service provider in the data communication network by the network element of the mobile communication network via the identified gateway between the mobile communication network and the data communication network.

2. The method according to claim 1, wherein the application or type of application requesting the communication connection is determined by the mobile terminal or the network element of the mobile communication network.

3. The method according to claim 1, wherein the application or type of application requesting the communication connection is determined by considering the communication address of the service provider, the kind of requested service, the kind of the requested communication connection and/or the name of the application requesting the communication connection.

4. The method according to claim 1, wherein the application or type of application is assigned an identifier, wherein the identifier is at least known to the mobile terminal and the network element of the mobile communication network.

5. The method according to claim 4, wherein the identifier of the application or type of application requesting the communication connection is assigned by the mobile terminal, the network element of the mobile communication network and/or the application or type of application requesting the communication connection.

6. The method according to claim 5, wherein the network element of the mobile communication network receiving the identifier of the application or type of application requesting the communication connection checks the received identifier of the application or type of application requesting the communication connection.

7. The method according to claim 6, wherein the check bases on the communication address of the service provider, the kind of requested service, the kind of the requested communication connection and/or the name of the application requesting the communication connection.

8. The method according to claim 1, wherein the location of the mobile terminal in the mobile communication network is determined by a cell of the mobile communication network where the mobile terminal resides, a GPS position of the mobile terminal transmitted from the mobile terminal to the network element of the mobile communication network and/or a triangulation process using transmission times of transmitted signals.

9. The method according to claim 1, wherein the gateway between the mobile communication network and the data communication network is identified by the network element of the mobile communication network by considering the determined application or type of application requesting the communication connection and the determined location of the mobile terminal in the mobile communication network with respect to transmission times, latency, available bandwidth, network congestion, number of communication networks and/or network elements involved, quality of service, security characteristics of the communication connection, the real distance between the mobile terminal and the service provider, the capacity and/or current workload of the service provider, or any combination thereof.

10. The method according to claim 1, wherein the gateway between the mobile communication network and the data communication network is dynamically identified by the network element of the mobile communication network for every request for establishing a specific communication connection between the mobile terminal in the mobile communication network and a specific service provider in the data communication network originating from a specific application or type of application of the mobile terminal.

11. The method according to claim 1, wherein different applications with similar requirements regarding communication connections are grouped to a type of application.

12. The method according to claim 1, wherein the mobile communication network is designed according to a telecommunication standard like 2G, 3G, 4G, 5G, Wireless LAN or WiMAX.

13. The method according to claim 1, wherein the network element is a mobility management entity, MME, of a mobile communication network according to the 4G standard.

14. The method according to claim 1, wherein the gateway between the mobile communication network and the data communication network is a data packet network gateway, PGW, of a mobile communication network according to the 4G standard.

15. A mobile terminal adapted to perform the method steps according to claim 1 performed by such a mobile terminal.

16. A network element of a mobile communication network adapted to perform the method steps according to claim 1 performed by such a network element of a mobile communication network.
